(19) United States
(12) Patent Application Publication
(10) Pub. No.: US 2025/0282395 A1
(43) Pub. Date: Sep. 11, 2025

(54) VEHICLE AND METHOD FOR ISSUING RECOMMENDATIONS TO A PERSON DRIVING THE VEHICLE TO TAKE OVER VEHICLE CONTROL

(71) Applicant: MERCEDES-BENZ GROUP AG, Stuttgart (DE)

(72) Inventors: Joana HOIS, Böblingen (DE); Alexander HANUSCHKIN, Karlsruhe (DE); Stefan STUDER, Stuttgart (DE)

(21) Appl. No.: 18/858,465

(22) PCT Filed: Apr. 3, 2023
(86) PCT No.: PCT/EP2023/058714

§ 371 Date: Oct. 21, 2024

(30) Foreign Application Priority Data
Apr. 22, 2022 (DE) 10 2022 001 383.5

(51) Int. Cl. B60W 60/00; B60W 40/09; B60W 50/00; B60W 50/14; B60W 50/16; G06N 3/08

(52) U.S. Cl. CPC B60W 60/005; B60W 40/09; B60W 50/0097; B60W 50/16; G06N 3/08; B60W 2050/0029; B60W 2050/0083; B60W 2050/143; B60W 2050/146; B60W 2556/65

(57) ABSTRACT

A vehicle has a recommendation system, which includes a data collection module, a prediction module, and a recommendation module. The data collection module collects vehicle data, surroundings data, and/or environmental data. The prediction module reads a driver profile from a multitude of driver profiles, each driver profile including a machine learning model trained specifically for the respective driver profile set up to read the vehicle data, surroundings data, and/or environmental data at least for a route portion lying ahead and to issue a predictive indication value as an output variable. The recommendation module compares the predictive indication value to an indication threshold value and prompts a recommendation to be issued for a person driving the vehicle or a driver assistance system to take over vehicle control depending on the position of the predictive indication value in relation to the indication threshold value.

BACKGROUND AND SUMMARY OF THE INVENTION

Exemplary embodiments of the invention relate to a vehicle having an at least partially automated operating mode and a method for issuing recommendations to a person, driving the vehicle, of the vehicle.

Modern vehicles are increasingly fitted with driver assistance systems. Driver assistance systems serve to support the person driving the vehicle when taking over the driving tasks. In doing so, the degree of safety in road traffic, the efficiency when operating a vehicle, and the comfort for vehicle users can be increased. Here, various driver assistance systems are able to take over an at least partially automated control of the vehicle, in the future even autonomous control. A lane keeping assistant can keep to the driving lane currently being driven in by the vehicle when driving on a motorway, for example, adaptive cruise control can maintain the distance to the person in front, or a parking assistant can take over the lateral guidance of the vehicle when reversing into a parking space while the person driving the vehicle takes over the longitudinal guidance.

To use a driver assistance system which enables an at least partially automated vehicle control, boundary conditions must be present in a driving situation, the conditions allowing application of the driver assistance system. Thus, the sensors used to detect the surroundings, for example, may not be disturbed in their detection and must provide sufficiently workable sensor data, or a certain driving state must be present, for example the progressive movement on a certain type of road within a set speed range. If an at least partially automated assistance function is available, then this typically has to first be manually activated. Here, however, it can happen that the driver of the vehicle does not use available assistance functions despite them being available. Reasons for this can be, for example, the loss of driving pleasure or the joy of self-driving or a lack of trust in the safety of the corresponding driver assistance system and loss of control. The corresponding advantages in terms of safety, efficiency and comfort that can potentially be generated by using the assistance function are lost as a result without being used.

A driving system and a method for activating a driving function for automated driving are known from DE 10 2017 208 504 A1. The method disclosed in the printed publication simplifies the operation of a driving system that provides an automated driving function. The method provides checking the availability of the corresponding automated driving function after the person driving the vehicle has input a request for an automated driving function and offering it to the person driving the vehicle if it is available. If an offer is available, the person driving the vehicle is able to accept the offer particularly comfortably, i.e., activate the automated driving function. To do so, it can already be sufficient for the person driving the vehicle to take their hands off the steering wheel to activate the automated driving function. In doing so, there is no longer the requirement for the person driving the vehicle to have to firstly manually check the general availability of the automated driving function while using their vehicle and, if there is availability, to then have to activate it by manually inputting an operating action.

Exemplary embodiments of the present invention are directed to an improved vehicle with an at least partially automated operating mode and a method for issuing recommendations to a driver of the vehicle to take over vehicle control, by means of which the proportion of use of an at least partially automated operation of the vehicle during a journey is increased.

According to the invention, a vehicle having an at least partially automated operating mode has a recommendation system comprising a data collection module, a prediction module and a recommendation module, wherein the data collection module is set up to collect vehicle data, surroundings data, and/or environmental data; the prediction module is set up to read a driver profile from a multitude of driver profiles, wherein each driver profile comprises a machine learning model individually trained for the respective driver profile, the machine learning model being set up to read the vehicle data, surroundings data and/or environmental data at least for a route portion lying ahead and to issue a predictive indication value as the output variable, wherein the predictive indication value is a numerical value; and the recommendation module is set up to compare the predictive indication value to an indication threshold value and to prompt a recommendation for a person driving the vehicle to take over manual vehicle control to be issued in the vehicle, when the predictive indication value is in a first range in comparison to the indication threshold value and to prompt a recommendation for a driver assistance system to take over an at least partially automated vehicle control to be issued in the vehicle, when the predictive indication value lies in a second region in comparison to the indication threshold value.

The vehicle according to the invention is able to issue a suggestion to the person driving the vehicle to take over the manual vehicle control taking into consideration their driving style exactly when the person driving the vehicle would probably like to take over control of the vehicle themselves, corresponding to their personal vehicle usage preferences and to issue a recommendation for a driver assistance system to take over the vehicle control, when the corresponding driver assistance function is available and the person driving the vehicle here would probably not like to control the vehicle themselves. In other words, the vehicle issues a recommendation to the person driving the vehicle to take over an at least partially automated vehicle control when the person driving the vehicle would also very probably issue this request. In doing so, the degree of workload of the at least partially automated vehicle control during a journey with the vehicle is increased.

If a situation is present in which an at least partially automated vehicle control is possible, then the person driving the vehicle is pointed towards passing the vehicle control over to the driver assistance system, whereby this function remaining unused on a road on which an at least partially automated vehicle control is possible is avoided. However, there is the possibility that, despite at least partially automated driving functions being available, the person driving the vehicle does not want to relinquish the control of the vehicle, for example because the person driving the vehicle experiences a lot of driving pleasure on the route portion. In such a case, issuing the recommendation to pass the vehicle control over to the vehicle does not happen, which increases the comfort of the person driving the vehicle, since no unnecessary recommendations are issued. It is also possible that the at least partially automated vehicle control is active and the vehicle nevertheless issues a recommendation to the person driving the vehicle to take over manual vehicle control. Thus, depending on the personal preferences of the person driving the vehicle, the vehicle determines on which route portions the person driving the vehicle would probably like to control the vehicle themselves and issues corresponding recommendations. In doing so, it is ensured that the person driving the vehicle also controls the vehicle themselves when corresponding route portions are driven along which cause an increased degree of driving pleasure. In doing so, the acceptance of the use of at least partially automated driving functions gradually increases for the person driving the vehicle, such that when the at least partially automated driving functions is available, they also increasingly use it.

Thus, a recommendation to take over the at least partially automated vehicle control is issued by the vehicle when a monotonous and boring route portion for the person driving the vehicle is coming up during the journey, such that the person driving the vehicle also here correspondingly gladly relinquishes vehicle control to the at least partially automated driver assistance system. Here, the vehicle reads the preferences of the person driving the vehicle from the driver profile and, in doing so, also recognizes upcoming situations in which the person driving the vehicle would otherwise gladly manually control their vehicle, yet currently does not want to due to changed boundary conditions, for example because there is too much traffic and/or adverse weather conditions and/or a telephone conversation is currently in progress and/or further passengers are in the vehicle. Thus, the vehicle recognizes an upcoming driving situation in which driving safety can be increased compared to a manual control as a result of an at least partially automated control, whereupon the person driving the vehicle relinquishes the vehicle to the driver assistance system since, in doing so, the feeling of safety of the person driving the vehicle is increased.

Here, the vehicle can have any degree of automation. The vehicle can thus be able to be controlled in an at least partially automated manner, which corresponds to an assisted vehicle control by the driver assistance system. Thus, the driver assistance system, for example, can assume the vehicle transverse or vehicle longitudinal control, wherein the corresponding remaining vehicle longitudinal or transverse control is assumed by the person driving the vehicle. However, the vehicle can also be controlled in a highly automated or completely automated manner, or even autonomously. In the autonomous operating mode, interventions by the person driving the vehicle are no longer necessary, such that the vehicle can generally perform its driving task even when the person driving the vehicle is absent or distracted.

The data collection module here collects vehicle data, surroundings data, and/or environmental data. Vehicle data includes information recorded by means of sensors by the vehicle itself and information relating to the vehicle, such as a forward movement speed, vehicle acceleration, vehicle position, steering angle, accelerator pedal position, or similar, for example. Surroundings data includes information ascertained by the vehicle itself and relating to the closer surroundings of the vehicle, such as a route, for example determined by evaluating camera images generated by a surroundings camera, a self-measured road surface condition, a road width, a measured surroundings temperature, traffic rules displayed by road signs, construction sites, and other obstacles in the region of the road, for example also recognized in the camera images generated by the surroundings camera, precipitation detected by means of a dampness sensor, or similar. Environmental data includes information relating to the surroundings of the vehicle, which are obtained from outside the vehicle or read from a memory. Here, this includes the route, for example, read from a digital roadmap, and the traffic rules applying to the route, traffic information relating to a traffic service, a weather report, and similar. Using the surroundings data, environmental data can be verified. Moreover, the corresponding data can also be predicted for a route portion lying ahead. Thus, a route, for example, can be read from a digital road map or determined for the next 200 meters from camera images and the steering angle expected when driving along the corresponding route portion, acceleration values and forward movement speed predicted. To process this “heterogenic” data, the prediction module can also use methods for semantic networks, such as knowledge graphs and/or ontologies.

The vehicle data, surroundings data, and/or environmental data can have an effect on the control behavior of the person driving the vehicle, and are thus taken into consideration for ascertaining the recommendation for taking over a manual or at least partially automated vehicle control. For example, a sporty driver might want to manually drive the vehicle along a stretch that has a large number of corners. If, however, slipperiness is to be expected, for example caused by wetness or temperatures below freezing point, then the person driving the vehicle can, however, want at least partially automated vehicle control. A further example of a driving situation in which at least partially automated vehicle control is desired by the person driving the vehicle, is, for example, a monotonous driving situation, such as a traffic jam or stop-go traffic, or when driving along a particularly long route portion with a constant speed limit. Taking into consideration, in particular, the vehicle data, surroundings data, and environmental data, various driving situations can thus be recognized and distinguished in a particularly nuanced manner.

In abstract terms, the relationships between how a person with a certain driving style would manually control their vehicle depending on boundary conditions describing a respective driving situation are stored in the driver profiles. The boundary conditions are described here by the vehicle data, surroundings data, and/or environmental data. Processing the boundary conditions is then carried out by a machine learning model trained corresponding to the respective driving style of respective driver profiles and stored in the prediction model. Here, the person driving the vehicle initially specifies, for example when purchasing the vehicle or at the start of each journey, which driver profile they feel assigned to for their vehicle. The prediction module then selects the machine learning model or Heuristic model associated with the selected driving style from a memory allocated to it and reads it. The entirety of the driver profiles can be predetermined, for example, by a vehicle manufacturer. Here, a certain number of standard driver profiles can be predefined. Examples of driver profiles can be: sporty, proactive, safe, learner driver, no longer young or physically impaired drivers, or similar.

As the input data, the machine learning model reads the vehicle data, surroundings data and/or environmental data, i.e., for example a brake pedal position expected for the route portion lying ahead, steering angles, acceleration values, position values, congestion notifications, height profiles, courses of the road, weather information, and similar. As output variables, the predictive indication value is issued. This corresponds to a numerical value within a predetermined range of values, for example between 0 and 1 or −1 and 1. Differently trained machine learning models are then provided for different driver profiles.

To train the different machine learning models, different drivers are given a driving task for different courses of the road and specify for the respective route portions whether manual or at least partially automated vehicle control is preferred. In doing so, the different machine learning models learn how the vehicle is preferably to be controlled depending on the driving style associated with the driver profile, depending on a respective course of the road and the boundary conditions described by the vehicle data, surroundings data, and/or environmental data. Correspondingly, the different machine learning models then issue predictive indication values apposite to the respective courses of the road.

The predictive indication value is then compared to the indication threshold value by the recommendation module and, depending on the result for the route portion lying ahead, the recommendation for manual vehicle control or for at least partially automated vehicle control is issued.

The indication threshold value can be predetermined as a fixed value. For example, the indication threshold value can be 0.5. The first range can, for example, then be a range of between 0.5 and 1, and the second range of between 0 and 0.5. The first or second range can also comprise the value “0.5”. For example, the first range lies in the value range of from 0.5 and 1 and the second range in the value range of from 0 to 0.499 or vice versa. Here, the first and/or second ranges do not necessarily lie above or below the indication threshold value. The first and second range can also be understood as a ratio. For example, the first range can correspond to a range of ≥1 and the second range of a range of between 0 and 1. The first range can also correspond to a positive range and the second range to a negative range or vice versa.

Issuing the recommendation to take over the driving control can be carried out in the vehicle in many ways, for example acoustically, visually, and/or haptically. For example, the steering wheel of the vehicle can vibrate when a new recommendation is issued. The recommendation can then be reproduced acoustically as text, for example as the following spoken message: “a curved route portion lies ahead. Manual vehicle control is recommended.”. The corresponding message, optionally supplemented with pictograms, symbols, images, animations, or similar, can also be depicted on any display device in the vehicle, for example in the instrument cluster or on the display of the head unit.

The vehicle can determine the route portion lying ahead in different ways. For example, the vehicle can have a navigation system, into which a route is programmed. The route is then divided into route portions. Corresponding route portions lying ahead then emerge from the route still to be covered by the vehicle. If the route control is inactive, the so-called most probable path, which the navigation system determines based on historical data, can also be used. If the route control is inactive, the vehicle can determine a route portion lying immediately ahead as the route portion lying ahead. For example, the next 100 m driving distance can be determined as the next route portion lying ahead. If crossroads, exits, slip roads or similar lie on the route portion lying ahead, then the next route portion lying ahead can also extend up to such a road element. The vehicle is also able to determine a route portion lying ahead without a navigation system. To do so, the vehicle can evaluate the vehicle data and determine, for example, a route course itself. To do so, the vehicle can recognize the route course lying immediately ahead by means of deep information sensors, such as a stereo camera, a LIDAR, an ultrasonic sensor and/or a radar system.

An advantageous development of the vehicle provides that the recommendation system furthermore comprises a driver monitoring module, which is set up to monitor the person driving the vehicle by means of at least one sensor and to ascertain a current control behavior and/or a current driver state from sensor data generated by the sensor and to allocate the person driving the vehicle one of the driver profiles depending on the determined current control behavior and/or the current driver state. Thus, the driving behavior of the person driving the vehicle is recognized gradually and a driver profile adequately suitable for the corresponding driving behavior is selected by the vehicle, whereby other predictive indication values are issued. In doing so, the comfort for the person driving the vehicle can be increased further still, since the degree of correspondence between the actual driving style of the person driving the vehicle and the driving style assumed by the vehicle is thus increased, whereby the recommendation system is put in a position to be able to issue even more accurate recommendations to take over the vehicle control. In doing so, the probability of the recommendations issued by the vehicle to take over the driving control also actually being implemented by the person driving the vehicle increases.

To record the current control behavior, the steering behavior and acceleration or braking behavior of the person driving the vehicle can be analyzed. To do so, the steering angle correspondingly set during the journey and pedal positions are recorded and analyzed by the driver monitoring module.

The driver state describes, in particular, an emotional mood, attention, and/or degree of cognitive load of the person driving the vehicle. To do so, vital parameters of the person driving the vehicle are monitored, such as pulse frequency, breathing frequency, skin conductivity, skin temperature, gaze direction, blinking frequency, gaze direction change frequency, and similar. For example, an increased pulse frequency, increased skin conductivity and/or body temperature can indicate an increased concentration and/or the experience of driving enjoyment.

Thus, a person driving the vehicle, for example, who remains calm in a hectic traffic situation and/or is stressed in a monotonous traffic situation, is allocated a sporty driver profile, and a person who is flustered in a hectic traffic situation and/or is relaxed in a monotonous traffic situation is allocated a comfortable driver profile.

The prediction module can furthermore be set up to predict predicted control behavior and/or a predicted driver state for a route portion lying ahead, i.e., expected current driving behavior that is likely to occur on the route portion lying ahead and/or driver state. Thus, the predicted control behavior can be compared to the current control behavior and/or the predicted driver state to the current driver state, in order to assess a forecast quality of the prediction module, in particular of a respective machine learning model underlying the corresponding driver profile.

To allocate a fitting driver profile for the person driving the vehicle, the implementation behavior can also use the recommendation issued by the vehicle to take over the vehicle control. If the person driving the vehicle follows the recommendation of the vehicle more often than a fixed threshold value, then the vehicle assumes that an adequate driver profile has been selected. On the other hand, if the person driving the vehicle does not follow the recommendation made by the vehicle to take over the vehicle control or does so less often than the set threshold value, then a new driver profile is preferably set.

A predefined “standard driver profile” can furthermore be adjusted to the actual driving style of the person driving the vehicle depending on the actual control behavior and/or driver state of the person driving the vehicle using the usage duration of their vehicle and additionally be improved in terms of its forecast quality through constant training. To do so, corresponding to a further advantageous design of the vehicle, the driver monitor module is furthermore set up to determine a current indication value from current data such as the current control behavior and/or the current driver state, and the prediction module is further set up to read the current control behavior, the current driver state and/or the current indication value and thus to further train the machine learning module. With the current data mentioned above and the data also currently read by the data collection module of the surroundings and/or environment, the machine learning model or the Heuristic model can be continuously further trained for a route portion currently being driven on. In doing so, the forecast quality of the machine learning model is improved further still for the route portions lying ahead, such that the recommendations issued by the recommendation system are implemented even more frequently by the person driving the vehicle.

The predicted control behavior and/or the predicted driver state can also be input into the machine learning model as input variables for determining the predictive indication value. By means of a comparison to the current control behavior and/or the current driver state, the prediction module can check how well it has predicted the predicted control behavior and/or the predicted driver state. The machine learning model correspondingly learns and improves its forecast quality.

Analogously, a machine learning model trained for the respective driver profile can also be integrated into the driver monitoring module, in order to determine the current indication value from the current data. The current indication value issued by the driver monitoring module can then also be taken into consideration by the prediction module, in order to check the forecast quality of the predictive indication value by means of the current indication value and to adjust the machine learning model to eliminate errors.

A further advantageous design of the vehicle furthermore provides that the prediction module is further set up to further train the machine learning model taking into consideration an actual implementation of the recommendation made by the recommendation module to take over the vehicle control. A corresponding result as to whether the recommendation for manual or at least partially automated takeover of the vehicle control has also actually been implemented by the person driving the vehicle or declined, can be transmitted back to the prediction module as feedback by a control device, whereby the machine learning model or the Heuristic model and the prediction made with it is improved further.

According to a further advantageous design of the vehicle, the recommendation system is set up to receive fleet data, wherein the fleet data comprises an aggregated amount of user-specific control behavior and/or driver states of the user and corresponding surroundings and environmental data of a plurality of fleet vehicles, and to derive driver profiles from the fleet data and/or to update an existing driver profile, wherein control behavior and/or driver states that are similar within set limits are allocated to the same driver profile. By collecting and using the fleet data, the corresponding machine learning models of the respective derived driver profiles can be trained using particularly comprehensive datasets. This makes it possible to develop particularly substantial and nuanced driver profiles, such that a particularly appropriate machine learning model can be developed for each person driving the vehicle or the individual vehicle users can be allocated to these. Due to the use of these large datasets, the individual machine learning models specific to the driver profile are additionally particularly appropriately trained. This means that the forecast quality of the respective machine learning models can be increased for the respective driver profiles, such that the respective recommendations issued by the recommendation system can also actually be implemented whenever possible.

In addition to the user-specific control behavior, here the respective user-specific driver state can also be taken into consideration. Thus, the control behavior can be coupled to the driver state, such that a driver state specific to the driver profile is present for a certain route portion or vehicle data, surroundings data and/or environmental data. In the event of a particularly steep and curved route with frequently changing and strong steering deflections and strong acceleration and delay behavior, a first driver state can then indicate, for example, a high cognitive load and nerves, and a second driver state an average cognitive load and enjoyment. Correspondingly, the person with the first driver state can be allocated to a nervous driver profile and a person with the second driver state a sporty driver profile.

In a further advantageous additional or alternative design of the vehicle, the recommendation system is set up to receive fleet data, wherein the fleet data furthermore comprises the implementation behavior of the recommendations made by the recommendation modules of the fleet vehicles by the users of the fleet vehicles, and the prediction module is furthermore set up to improve or to further train the machine learning model taking into consideration the implementation behavior of the users of the driver profile allocated to the person driving the vehicle. This can be understood as a filter, such that before the machine learning model is further trained, the corresponding input data used for further training has actually led to an improvement of the implementation of the recommendations issued for a large number of fleet vehicle users. In doing so, a deterioration of the machine learning model is prevented, which could lead to a reduced implementation of the corresponding recommendations. For example, depending on the vehicle data, surroundings data and/or environmental data or predicted control behaviors derived from this or driver states, route portions can be ascertained, in which at least one set number of users also actually implements the recommendations issued, for example at least 75% of the users.

Corresponding to a further advantageous design of the vehicle, the machine learning module comprises a neural network. By means of a neural network—but also comparable methods of machine learning—the machine learning model is particularly reliably able to determine an appropriate predictive indication value depending on the input parameters.

A further advantageous design of the vehicle furthermore provides that a vehicle control device is set up to automatically implement the recommendation made by the recommendation system for the person driving the vehicle or the driver assistance system to take over vehicle control. In doing so, the comfort for the person driving the vehicle can be improved even further. Thus, the person driving the vehicle does not have to enter a manual operating action each time a corresponding recommendation is issued for the recommendation to be followed. The vehicle can thus automatically implement the corresponding recommendation, i.e., activate or deactivate an at least partially automated vehicle control. The person driving the vehicle can set in a configuration menu, for example, that the automated take-over of the recommendation is to be carried out for certain boundary conditions. Thus, it is furthermore necessary in certain situations that the person driving the vehicle only has to proactively input on the issued recommendation until the recommendation is also implemented. For example, the at least partially automated vehicle control can always be automatically activated and the take-over of the manual vehicle control only after confirmation by the person driving the vehicle.

The recommendation module is preferably further set up to adjust the height of the indication threshold value depending on a driver profile read by the prediction module, the vehicle data, surroundings data, and/or environmental data. In doing so, a particularly simple, quick, and flexible reaction is possible in order to make a decision as to which operating mode of the vehicle is to be recommended. If the threshold value is initially 0.5, for example, then it can be increased or reduced depending on the driver profile. For example, it can thus be reduced to 0.3 for the “Sporty” driver profile when the recommendation for manual vehicle control is issued for indication values that are closer to 1 in comparison and raised to 0.8 for the “Safety” driver profile, for example. Thus, the vehicle can analyze a route portion lying ahead and set the indication threshold to 0.7 for a monotonous route portion and to 0.33 for an exciting route portion.

According to the invention, a method for issuing recommendations to a person driving a vehicle of a vehicle described above for the person driving the vehicle to take over manual control or for the driver assistance system to take over an at least partially automated vehicle control comprises the following steps:
Collecting vehicle data, surroundings data, and/or environmental data by a data collection module;
Reading a driver profile from a number of driver profiles by a prediction module, wherein each driver module comprises a machine learning model individually learned for the respective driver profile, which is set up to read the vehicle data, surroundings data, and/or environmental data at least for a route portion lying ahead and to issue a predictive indication value as the output value, wherein the predictive indication value is a numerical value;
Determining the predictive indication value for the route portion lying ahead by the prediction module; and
Comparing the predictive indication value to an indication threshold value and prompting issuance of a recommendation in the vehicle for the person driving the vehicle to take over manual vehicle control when the predictive indication value compared to the indication threshold value lies in a first range and prompting the issuance of a recommendation in the vehicle for a driver assistance system to take over an at least partially automated vehicle control when the predictive indication value in comparison to the threshold value lies in a second range, by a recommendation module.

By means of the method according to the invention, recommendations for the person driving the vehicle of the vehicle to take over a manual or at least partially automated vehicle control are issued in the vehicle. Here, issuing the respective recommendation to the respective driver profile is tailored such that a recommendation for manual vehicle control is issued exactly when there is a particularly high probability that the person driving the vehicle would also actually like to control their vehicle and correspondingly a recommendation for at least partially automated driving control is issued when the person driving the vehicle wants at least partially automated driving control or at least has nothing against it. This ensures an improved acceptance of driver assistance systems, which enable an at least partially automated vehicle control and thus increases the usage proportion of the at least partially automated vehicle control when carrying out a journey.

Further advantageous designs of the vehicle according to the invention emerge from the exemplary embodiments, which are described below in more detail with reference to the figures.

### BRIEF DESCRIPTION OF THE DRAWING FIGURES

Here are shown:

FIG. 1 a schematic depiction of a vehicle according to the invention; and

FIG. 2 a schematic depiction of the information transfer paths of the values read and issued by a machine learning model conducted on a prediction module.

### DETAILED DESCRIPTION

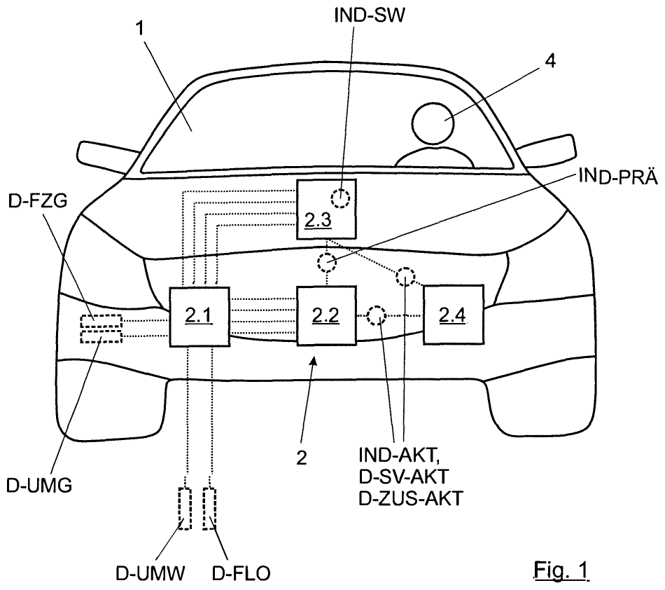

FIG. 1 shows, in a schematic front view, a vehicle 1 according to the invention. The vehicle 1 comprises a recommendation system 2, comprising a data collection module 2.1, a prediction module 2.2, a recommendation module 2.3, and a driver monitoring module 2.4.

The vehicle 1 has an at least partially automated operating mode. Depending on different boundary conditions, the at least partially automated driving mode is available and allows a person 4 driving the vehicle to control the vehicle 1 with at least partial automation. For example, this can here be adaptive cruise control, a lane keeping assistant, a parking assistant, or also an autopilot, i.e., an autonomous control of the vehicle 1. The vehicle 1 according to the invention is able to issue a recommendation to the person 4 driving the vehicle as to whether manual vehicle driving is to be carried out by the person 4 driving the vehicle or an at least partially automated vehicle control by a driver assistant system on a route portion lying ahead in a journey carried out by the vehicle 1. Here, the vehicle 1 is oriented to the preferences of the person 4 driving the vehicle, such that a recommendation for manual vehicle control is issued exactly when the person 4 driving the vehicle would most probably like to control the vehicle themselves and a recommendation for at least partially automated vehicle control is issued when the at least partially automated vehicle control most probably contributes to an increased degree of user comfort for the person 4 driving the vehicle.

To do so, vehicle data D-FZG, surroundings data D-UMG, and environmental data D-UMW are collected by the data collection module 2.1. The vehicle data D-FZG is information recorded by the vehicle 1 itself and relating to the vehicle 1, such as forward movement speed, position or orientation in space, acceleration values, a pedal position, and similar. The surroundings data D-UMG is information recorded by the vehicle 1 relating to the surroundings of the vehicle 1, such as route, valid traffic regulations, surroundings temperature, present precipitation, or similar. To record the route, the vehicle 1 can detect its surroundings by means of surroundings sensors such as a mono- or stereo camera, a LIDAR, ultrasound sensors, and/or a radar system, and determine the route from corresponding sensor data. The environmental data D-UMW includes information relating to the environment read by the vehicle 1 externally or from a data memory, such as a route read from a digital road map, traffic regulations stored in the digital road map, in particular for the section of road ahead, traffic information obtained from a traffic service, weather reports obtained from a weather service, and similar.

In addition, the driver monitoring module 2.4 is equipped with various sensors to monitor the person 4 driving the vehicle and to record a current steering behavior D-SV-AKT and a current driver state D-ZUS-AKT. The current control behavior D-SV-AKT includes, for example, the steering behavior and/or the acceleration or braking behavior of the person 4 driving the vehicle, derived from a steering angle sensor and/or a pedal position sensor. The current driver state D-ZUS-AKT describes, for example, the emotional mood, alertness, degree of cognitive stress caused by the driving task or similar of the person 4 driving the vehicle. To do so, the person 4 driving the vehicle can be monitored by means of various sensors, whereby vital parameters can be recorded. The corresponding variables taken into account for assessing the driver state can then be derived from the vital parameters. The vital parameters include, for example, a pulse rate, a blinking rate, a facial expression of the person 4 driving the vehicle derived from visual monitoring using image recognition algorithms, for example whether the person 4 driving the vehicle is smiling, a skin conductivity, a skin temperature, a gaze direction, a gaze direction change frequency, and similar.

Furthermore, the recommendation system 2 can receive fleet data D-FLO, for example also via the data collection module 2.1. The fleet data D-FLO comprises the control behavior of a plurality of different users of the vehicles 1 in a vehicle fleet and/or their driver states. Various driver profiles can be derived from this control behavior and/or driver states, which are representative of a respective individual driving style and the emotions experienced in the process.

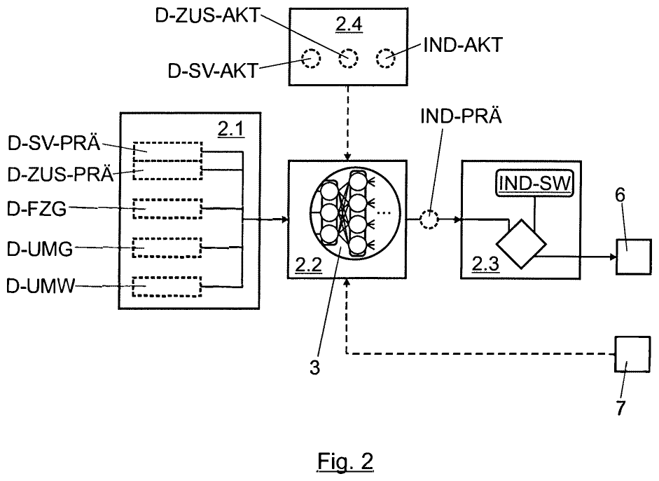

For example, before using their vehicle 1, the person 4 driving the vehicle selects the driver profile to which they feel they belong, for example a sporty or a comfortable driver profile. Depending on the selected driver profile, the prediction module 2.2 then determines the trained machine learning model or Heuristic model, which determines for a route portion lying ahead whether the person 4 driving the vehicle would probably prefer to drive the vehicle 1 manually or at least in a partially automated manner. The selected machine learning module or the Heuristic model of the prediction module 2.2 processes the corresponding vehicle data D-FZG, surroundings data D-UMG, and/or environmental data D-UMW expected at least for the route portion lying ahead and is thus able to realistically predict the driving situation that will occur on the route portion lying ahead. A respective driver profile is representative of the expected manual control behavior of the person 4 driving the vehicle depending on the expected driving situation on the route portion lying ahead. In doing so, the prediction module 2.2 is able to predict a manual control behavior expected by the person 4 driving the vehicle on the route portion lying ahead. Additionally, or alternatively, the prediction module 2.2 can also estimate an expected driver state. By comparing the expected manual control behavior, an expected selection of an automated driving mode, and/or the expected driver state with the expected driving situation on the route portion lying ahead, the prediction module 2.2 then estimates whether manual or at least partially automated vehicle control is likely to be desired or advisable or safer. In order to carry out these abstractly described process steps, the prediction module 2.2 comprises the machine learning model 3 shown in FIG. 2 for each driver profile, which is individually trained for the respective driver profile. The machine learning model 3 reads at least the vehicle data D-FZG, surroundings data D-UMG and/or environmental data D-UMW as input data. As an output variable, the machine learning model 3 provides a predictive indication value, which is a simple numerical value. Here, it can be a natural number, integer, rational number, or even a rounded irrational number. The predictive indication value can be assigned to a permissible value range, for example a value range of from −1 to 1 or from 0 to 1 or similar. The predictive indication value can be understood as a value that describes the affinity of the person 4 driving the vehicle for controlling the vehicle 1 by manual operation or by operating in an at least partially automated manner by a driver assistance system.

The machine learning models 3 specific to the driver profile are initially trained by the vehicle manufacturer. To do so, predefined driving situations are driven by different people with different driving styles and it is then checked as to whether manual or at least partially automated vehicle control is desired for the respective driving situation. In particular, the machine learning model 3 comprises an artificial neural network, whereby the individual neurons of the artificial neural network form corresponding links through the learning process, such that a predictive indication value IND-PRÄ that respectively matches the driving style and the driving situation can be determined.

The predictive indication value IND-PRA is then scanned by the recommendation module 2.3 and compared with an indication threshold value IND-SW. For example, the value range of the predictive indication value IND-PRA can range from −1 to 1, and the indication threshold value IND-SW can be 0. If the predictive indication value IND-PRA is then in a first range compared to the indication threshold value IND-SW, for example in the range of between 0 and 1, a recommendation to take over manual vehicle control is issued in vehicle 1. If, on the other hand, the predictive indication value IND-PRA is in a second range compared to the indication threshold value IND-SW, for example between −1 and 0, then a recommendation to take over at least partially automated vehicle control by a driver assistance system is issued in vehicle 1. If the predictive indication value IND-PRA and the indication threshold value IND-SW have the same value, a recommendation to take over control of the vehicle may not be issued or a preset standard recommendation may be issued, for example.

FIG. 2 again shows a more exact depiction of the information transfer paths of the values read and issued by the machine learning model 3.

The recommendation issued in the vehicle 1 can be issued haptically, acoustically, and/or visually. Issuing is carried out on a corresponding issuing device 6. Here, it can be, for example, an actuator, a loudspeaker, or a display device.

The driver monitoring module 2.4 can be used to determine a current control behavior D-SV-AKT of the person 4 driving the vehicle and/or a current driver state D-ZUS-AKT. A correspondingly trained machine learning model 3 can also be integrated into the driver monitoring module 2.4, which determines a current indication value IND-AKT from the current control behavior D-SV-AKT and/or the current driver state D-ZUS-AKT. These variables can be read by the prediction module 2.2 in order to further train the machine learning model 3 corresponding to the driver profile, such that the forecast quality of the actual affinity of the person 4 driving the vehicle is improved. Additionally, or alternatively, a control unit 7 can determine the implementation behavior of the person driving the vehicle 4, i.e., whether the person 4 driving the vehicle has followed the recommendation issued by the recommendation system 2, and transmit it as feedback to the prediction module 2.2. The prediction module 2.2 can also use this information to further train the corresponding machine learning model 3.

Furthermore, in an alternative development, the driver monitoring module 2.4 is able to analyze the driving behavior of the person 4 driving the vehicle by recording the current control behavior D-SV-AKT and/or the current driver state D-ZUS-AKT and in doing so carry out an initial allocation or reallocation of the person 4 driving the vehicle to a corresponding driver profile. This allows the person 4 driving the vehicle to estimate which driver profile is most suitable for them, but the driver monitoring module 2.4 can check this estimate and thus select a driver profile that is even better suited to the actual driving behavior of the person 4 driving the vehicle. Through the continuous further training and personalized storage of the machine learning model 3, the corresponding driver profile of the person 4 driving the vehicle is tailored and adapted even more accurately to this person. Since this is also carried out for all vehicles 1 in a vehicle fleet, a large number of particularly realistic driver profiles can be defined and distributed to the individual vehicles 1 in the vehicle fleet. In doing so, the forecast quality of the corresponding machine learning models 3 allocated to the various driver profiles is gradually improved, such that there is a very high probability that the recommendations issued in the vehicles 1 will actually be implemented by the respective people 4 driving the vehicle in the same way.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A vehicle, comprising:
a recommendation system comprising a data collection module, a prediction module, and a recommendation module,
wherein the data collection module is configured to collect vehicle data, surroundings data, or environmental data,
wherein the prediction module is configured to read a driver profile from a plurality of driver profiles, wherein each driver profile of the plurality of driver profiles comprises a machine learning model trained specifically for the respective driver profile or comprises Heuristic model, wherein the machine learning model or the Hueristic model is configured to read the vehicle data, surroundings data, or environmental data at least for a route portion lying ahead of the vehicle and to issue a predictive indication value as an output variable, wherein the predictive indication value is a numerical value; and
wherein the recommendation module is configured to compare the predictive indication value to an indication threshold value and to
prompt a recommendation to be issued in the vehicle for a person driving the vehicle to take over manual vehicle control when the predictive indication value compared to the indication threshold is in a first range, and
prompt a recommendation to be issued in the vehicle for a driver assistance system of the vehicle to take over an at least partially automated vehicle control when the predictive indication value compared to the indication threshold value is in a second range.

12. The vehicle of claim 11, wherein the recommendation system further comprises a driver monitoring module configured to
monitor the person driving the vehicle using at least one sensor of the vehicle,
determine current control behavior or a current driver state from sensor data generated by the at least one sensor,
allocate the person driving the vehicle to one of the plurality of driver profiles depending on the determined current control behavior or the determined current driver state.

13. The vehicle of claim 12, wherein the vehicle monitoring module is further configured to determine a current indication value from the current control behavior or the current driver state, and the prediction module is further configured to read the current control behavior, the current driver state, or the current indication value to further optimize the machine learning model or the Heuristic model.

14. The vehicle of claim 11, wherein the prediction module is further configured to further train the machine learning model or the Heuristic model, taking into consideration a current implementation of the recommendation made by the recommendation module for taking over the vehicle control.

15. The vehicle of claim 11, wherein the recommendation system is
configured to receive fleet data, wherein the fleet data comprises an aggregated amount of user-specific control behavior or vehicle states of users of a plurality of fleet vehicles, and
configured to derive driver profiles from the fleet data or to update an existing driver profile, wherein control behavior or vehicle states that are similar within set limits are allocated to the same driver profile.

16. The vehicle of claim 15, wherein the fleet data further comprises implementation behavior of the recommendations made by the recommendation modules of the fleet vehicles by the users of the fleet vehicles, and the prediction module is furthermore configured to further optimize the machine learning model or the Heuristic model taking into consideration the implementation behavior of the users of the driver profile allocated to the person driving the vehicle.

17. The vehicle of claim 11, wherein the machine learning model comprises a neural network or the machine learning model is initially assigned based on Heuristic functions.

18. The vehicle of claim 11, further comprising:
a vehicle control device configured to automatically implement the recommendation made by the recommendation system for the person driving the vehicle or the driver assistance system to take over vehicle control.

19. The vehicle of claim 11, wherein the recommendation module is further configured to adjust a height of the indication threshold value depending on a driver profile read by the prediction module, the vehicle data, surroundings data, or environmental data.

20. A method comprising:
collecting, by a data collection module of a vehicle, vehicle data, surroundings data, or environmental data;
reading, by a prediction module of the vehicle, a driver profile from a plurality of driver profiles, wherein each driver profile of the plurality of driver profiles comprises a machine learning model individually trained for the respective driver profile or Heuristic model, wherein the machine learning model or the Heuristic model is configured to read the vehicle data, surroundings data, or environmental data at least for a route portion lying ahead of the vehicle and to issue a predictive indication value as the output value, wherein the predictive indication value is a numerical value;
determining, by the prediction module, the predictive indication value for the route portion lying ahead by the prediction module; and
comparing the predictive indication value to an indication threshold value and prompting issuance, by a recommendation module, of a recommendation in the vehicle for the person driving the vehicle to take over manual vehicle control when the predictive indication value compared to the indication threshold value lies in a first range and prompting the issuance of a recommendation in the vehicle for a driver assistance system to take over an at least partially automated vehicle control when the predictive indication value compared to the threshold value lies in a second range.
